(19) United States
(12) Patent Application Publication
(10) Pub. No.: US 2012/0231340 A1
(43) Pub. Date: Sep. 13, 2012

(54) TRANSITION-METAL-CONTAINING HYDROXIDE AND LITHIUM-CONTAINING METAL OXIDE

(75) Inventor: Yuichiro Imanari, Tsukuba-shi (JP)

(73) Assignee: SUMITOMO CHEMICAL COMPANY, LIMITED, Chuo-ku, Tokyo (JP)

(21) Appl. No.: 13/510,556

(22) PCT Filed: Nov. 9, 2010
(86) PCT No.: PCT/JP10/70256

§ 371 Date: May 17, 2012

(30) Foreign Application Priority Data
Nov. 20, 2009 (JP) 2009-264782

(51) Int. Cl. H01M 4/525

(52) U.S. Cl. 429/221; 252/182.1

(57) ABSTRACT

The present invention provides a transition metal mixed hydroxide and a lithium mixed metal oxide. The transition metal mixed hydroxide consists of primary particles and approximately spherical secondary particles formed by aggregation of primary particles, and has an average particle diameter of from 1 μm to 20 μm and contains Mn, Ni, Fe and Co in a molar ratio of a:b:c:d, wherein a is from 0.3 to 0.7, b is from 0.4 to 0.7, c is more than 0 and not more than 0.1, d is from 0 to 0.2, and a+b+c+d=1. The lithium mixed metal oxide is produced by calcining a mixture of the transition metal mixed hydroxide and a lithium compound, and has an average particle diameter of from 1 μm to 20 μm.

### TECHNICAL FIELD

The present invention relates to a transition metal mixed hydroxide and a lithium mixed metal oxide. More specifically, the present invention relates to a lithium mixed metal oxide to be used for a positive electrode active material in a non-aqueous electrolyte secondary battery and a transition metal mixed hydroxide to be used for a raw material of the lithium metal mixed oxide.

### BACKGROUND ART

A transition metal mixed hydroxide has been used as a raw material for a positive electrode active material in a non-aqueous electrolyte secondary battery such as a lithium secondary battery. The lithium secondary battery has already been put into practical use as a small-sized power supply for use in portable telephones, notebook personal computers, etc., and has also been tried to be applied to large-sized power supply for use in automobiles, power storage, etc.

For example, as disclosed in Patent Document 1, a conventional transition metal mixed hydroxide is produced by a method in which by adding an aqueous sodium hydroxide solution to an aqueous solution containing Mn, Ni, Fe and Co at a prescribed ratio, Mn, Ni, Fe and Co are coprecipitated to obtain a coprecipitation product, and then the coprecipitation product is heated and dried at 150° C.

### PRIOR ART DOCUMENT

### Patent Documents

### [Patent Document 1]: WO2002/073718

### DISCLOSURE OF THE INVENTION

However, the transition metal mixed hydroxide obtained by the above-mentioned conventional method has particles that are irregular in their shape. Therefore, a lithium mixed metal oxide obtained by using the transition metal mixed hydroxide as a raw material also has particles that are irregular in their shape. As a result, such a lithium mixed metal oxide causes low capacity and high resistivity in its inner resistance in a non-aqueous electrolyte secondary battery. An object of the present invention is to provide a lithium mixed metal oxide that provides a non-aqueous electrolyte secondary battery having higher capacity and lower inner resistance, and a transition metal mixed hydroxide to be used as a raw material for such a lithium mixed metal oxide.

The present invention provides the following means.

<1> A transition metal mixed hydroxide consisting of primary particles and approximately spherical secondary particles formed by aggregation of primary particles, wherein the transition metal mixed hydroxide has an average particle diameter of from 1 μm to 20 μm and contains Mn, Ni, Fe and Co in a molar ratio of a:b:c:d, wherein a is from 0.3 to 0.7, b is from 0.4 to 0.7, c is more than 0 and not more than 0.1, d is from 0 to 0.2, and a+b+c+d=1.
<2> The transition metal mixed hydroxide according to <1>, wherein a is larger than b.
<3> The transition metal mixed hydroxide according to <1> or <2>, wherein d is 0.
<4> The transition metal mixed hydroxide according to any one of <1> to <3>, wherein the average particle diameter is from 1 μm to 10 μm.
<5> A lithium mixed metal oxide produced by calcining a mixture of the transition metal mixed hydroxide according to any one of <1> to
<4> and a lithium compound, wherein the lithium mixed metal oxide has an average particle diameter of from 1 μm to 20 μm.
<6> An electrode comprising the lithium mixed oxide according to <5>.
<7> A non-aqueous electrolyte secondary battery comprising the electrode according to <6> as a positive electrode.
<8> The non-aqueous electrolyte secondary battery according to <7> further comprising a separator.
<9> The non-aqueous electrolyte secondary battery according to <8>, wherein the separator is composed of a laminated film which has a heat resistant porous layer and a porous film laminated to each other.

### MODES FOR CARRYING OUT THE INVENTION

### <Transition Metal Mixed Hydroxide>

The transition metal mixed hydroxide of the present invention consists of primary particles and approximately spherical secondary particles formed by aggregation of primary particles, wherein the transition metal mixed hydroxide has an average particle diameter of from 1 μm to 20 μm and contains Mn, Ni, Fe and Co in a molar ratio of a:b:c:d, wherein a is from 0.3 to 0.7, b is from 0.4 to 0.7, c is more than 0 and not more than 0.1, d is from 0 to 0.2, and a+b+c+d=1.

The transition metal mixed hydroxide can be also represented by the following formula (A):

(MnₐNi_{b}Fe_{c}Co_{d})Oₑ(OH)₂₋ₑ (A)

wherein a is from 0.3 to 0.7, b is from 0.4 to 0.7, c is more than 0 and not more than 0.1, d is from 0 to 0.2, e is from 0 to 1, and a+b+c+d=1.

The transition metal mixed hydroxide of the present invention has approximately spherical secondary particles. In the case where the particle shape of the secondary particles is not an approximately spherical shape (for example, irregular particles), the resultant lithium mixed metal oxide also has particles having irregular shapes. If such a lithium mixed metal oxide is used as a positive active material for a non-aqueous electrolyte secondary battery, the filling density of a positive electrode active material in an electrode becomes low to cause a subsequent reduction in battery capacity of the non-aqueous electrolyte secondary battery. When the filling density of the positive electrode active material in the electrode becomes low, the number of contact points between the positive electrode active material and a conductive material becomes small to cause an increase in inner resistance of the battery. Similarly to the transition metal mixed hydroxide, the resultant lithium mixed metal oxide preferably has approximately spherical secondary particles. The shape of the secondary particle can be confirmed by a scanning electron microscope (hereinafter, may be sometimes referred to as SEM). In the present invention, the approximately spherical secondary particles refer to those secondary particles in which, in the secondary particles confirmed by observing the transition metal mixed hydroxide and the lithium mixed metal oxide by an SEM, supposing that the major axis of the secondary particles is DL and the minor axis of the secondary particles is DS, a value (DL/DS) obtained by dividing DL by DS is from 1.0 to 1.5.

The transition metal mixed hydroxide of the present invention consists of primary particles and approximately spherical secondary particles formed by aggregation of primary particles, and the transition metal mixed hydroxide has an average particle diameter of from 1 μm to 20 μm. In the present invention, the average particle diameter refers to a particle diameter (D₅₀) at 50% accumulation viewed from the finest particle side of an accumulated particle size distribution curve on a volume basis obtained by a laser diffraction scattering particle size distribution measurement. In the transition metal mixed hydroxide of the present invention, when the average particle diameter is less than 1 μm, the particles forming the resultant lithium mixed metal oxide tend to be small. When such a lithium mixed metal oxide is used as a positive electrode active material for a non-aqueous electrolyte secondary battery, the filling density of a positive electrode active material in an electrode becomes low to cause a subsequent reduction in battery capacity of the non-aqueous electrolyte secondary battery. In the case where the average particle diameter is more than 20 μm, the particles forming the lithium mixed metal oxide tend to be large, and the inner resistance of the non-aqueous electrolyte secondary battery also tends to be great. From the viewpoints of further increasing the capacity of the non-aqueous electrolyte secondary battery and of further lowering the inner resistance of the battery, the transition metal mixed hydroxide preferably has an average particle diameter of from 1 μm to 10 μm. Similarly to the transition metal mixed hydroxide, the lithium mixed metal oxide preferably has an average particle diameter of from 1 μm to 20 μm, and more preferably from 1 μm to 10 μm.

In the present invention, the transition metal mixed hydroxide contains Mn, Ni and Fe. The transition metal mixed hydroxide may further contain Co. The molar ratio of Mn, Ni, Fe and Co is represented by a:b:c:d, wherein a is from 0.3 to 0.7, b is from 0.4 to 0.7, c is more than 0 and not more than 0.1, d is from 0 to 0.2, and a+b+c+d=1.

In the present invention, a represents a ratio of the amount by mol of Mn relative to the total amount by mol of Mn, Ni, Fe and Co. In the case where a is less than 0.3, it is not preferable because the cycling characteristics of the resultant non-aqueous electrolyte secondary battery are lowered, while in the case where a is more than 0.7, it is not preferable because the capacity of the resultant non-aqueous electrolyte secondary battery is reduced. From the viewpoints of further improving the capacity and cycling characteristics of the resultant non-aqueous electrolyte secondary battery, a is preferably from 0.4 to 0.65, and more preferably from 0.46 to 0.6.

In the present invention, b represents a ratio of the amount by mol of Ni relative to the total amount by mol of Mn, Ni, Fe and Co. In the case where b is less than 0.4, it is not preferable because the capacity of the resultant non-aqueous electrolyte secondary battery is reduced, while in the case where b is more than 0.7, it is not preferable because the cycling characteristics of the resultant non-aqueous electrolyte secondary battery are lowered. From the viewpoints of further improving the capacity and cycling characteristics of the resultant non-aqueous electrolyte secondary battery, b is preferably from 0.45 to 0.7, and more preferably from 0.46 to 0.6.

In the present invention, c represents a ratio of the amount by mol of Fe relative to the total amount by mol of Mn, Ni, Fe and Co. In the case where c is 0, it is not preferable because the cycling characteristics of the resultant non-aqueous electrolyte secondary battery are lowered, while in the case where c is more than 0.1, it is not preferable because the capacity of the resultant non-aqueous electrolyte secondary battery is reduced. From the viewpoints of further improving the capacity and cycling characteristics of the resultant non-aqueous electrolyte secondary battery, c is preferably from 0.01 to 0.09, and more preferably from 0.02 to 0.07.

In the present invention, d represents a ratio of the amount by mol of Co relative to the total amount by mol of Mn, Ni, Fe and Co. In the case where d is more than 0.2, it is not preferable in terms of costs, because a large amount of Co that is an expensive metal are used. Thus, d is preferably from 0 to 0.1, and more preferably 0. In the present invention, even in the case where d is 0, that is, in the case where expensive Co is not used, it is possible to obtain a non-aqueous electrolyte secondary battery that is superior in capacity and inner resistance.

In the above-mentioned formula (A), the average value of the formal oxidation numbers of the total transition metal may occasionally be varied depending on e. For example, when the value of e is 0, the average value of the formal oxidation numbers of the total transition metal is 2, and when the value of e is 1, the average value of the formal oxidation numbers of the total transition metal is 3. From the viewpoint of allowing the secondary particles of the transition metal mixed hydroxide to easily form an approximately spherical shape, e is preferably from 0 to 0.5, and more preferably 0.

From the viewpoint of improving the cycling characteristics of the resultant non-aqueous electrolyte secondary battery, a is preferably larger than b, that is, the amount by mol of Mn is preferably larger than the amount by mol of Ni.

One portion of Ni, Mn, Fe and Co in the transition metal mixed hydroxide of the present invention may be substituted with other elements. Examples of the other elements include B, Al, Ga, In, Si, Ge, Sn, P, Mg, Ca, Sr, Ba, Sc, Y, Zr, Hf, Nb, Ta, V, Cr, Mo, W, Tc, Ru, Rh, Ir, Pd, Cu, Ag, Zn, and lanthanoid.

### <Method for Producing Transition Metal Mixed Hydroxide>

Specific examples of a method for producing a transition metal mixed hydroxide include methods in which an aqueous transition metal solution containing Ni, Mn, Fe, and optionally Co, a complexing agent and an aqueous alkali metal solution are simultaneously supplied into a reaction vessel continuously to coprecipitate transition metal ions, thereby obtaining a slurry, and the slurry is solid-liquid separated and dried so that a transition metal mixed hydroxide is obtained.

In the case where a transition metal mixed hydroxide containing Mn, Ni and Fe is produced, the aqueous transition metal solution can be produced by, for example, precisely weighing water-soluble salts, each of which contains Mn, Ni or Fe, so as to obtain a Mn:Ni:Fe molar ratio of a:b:c, and dissolving these salts in water. The formal oxidation number of the transition metal in the water-soluble salt is preferably 2. In the case of using raw materials that are hardly dissolved in water, for example, when respective raw materials containing Ni, Mn and Fe are oxides, hydroxides, and metal materials, these raw materials may be dissolved in acids capable of dissolving these raw materials so as to produce an aqueous transition metal solution. In the case where a transition metal mixed hydroxide containing Mn, Ni, Fe and Co is produced, the aqueous transition metal solution is produced by, for example, precisely weighing water-soluble salts, each of which contains Mn, Ni, Fe or Co, so as to obtain a Mn:Ni:Fe:Co molar ratio of a:b:c:d, and dissolving these salts in water. The formal oxidation number of the transition metal in the water-soluble salt is preferably 2. In the case of using raw materials that are hardly dissolved in water, for example, when respective raw materials containing Ni, Mn, Fe and Co are oxides, hydroxides, and metal materials, these raw materials may be dissolved in acids capable of dissolving these raw materials so as to produce an aqueous transition metal solution.

Examples of the water-soluble salts include chlorides, sulfates, nitrates, carbonates, oxalates, and acetates of each of Mn, Ni, Fe and Co, and these water-soluble salts may be used in combination. Among these water-soluble salts, sulfates are preferably used.

Examples of the complexing agent include ammonia, ammonium hydroxide, ammonium sulfate, ammonium chloride, ammonium carbonate, and ammonium fluoride.

An aqueous alkali metal solution can be produced by dissolving water-soluble salt of alkali metal such as lithium, sodium or potassium in water. Specific examples of the water-soluble salt include lithium hydroxide, sodium hydroxide, and potassium hydroxide, and these alkali metal water-soluble salts may be used in combination. Among these water-soluble salts, sodium hydroxide or potassium hydroxide is preferably used.

In order to control the secondary particles in the transition metal mixed hydroxide so as to have an approximately spherical shape, upon continuous supply of the respective aqueous solutions, the pH of the liquid in the reaction vessel needs to be adjusted. The respective aqueous solutions are preferably supplied while the pH of the liquid in the reaction vessel is adjusted from 11 to 13. The temperature of the aqueous solution in the reaction vessel is preferably retained in a range from 30° C. to 80° C.; and thus, a coprecipitation product having more uniform composition can be obtained.

The secondary particles of the resultant transition metal mixed hydroxide have an approximately spherical shape. The average particle diameter of the secondary particles can be controlled by adjusting conditions, such as the supply rates of the respective aqueous solutions, the concentrations and pH's of the respective aqueous solutions. For example, with respect to the aqueous solutions, when the supply rate of each of the aqueous solutions is made faster, or when the concentration thereof is made higher, the average particle diameter of the secondary particles tends to become small, while, in the opposite case, the average particle diameter of the secondary particles tends to become large. In the case where the pH of the liquid in the reaction vessel is smaller than 11, the average particle diameter of the secondary particles tends to become large, while in the case where the pH of the liquid in the reaction vessel is greater than 13, the average particle diameter of the secondary particles tends to become small.

The solid-liquid separation of the slurry obtained by the coprecipitation may be carried out by any method. From the viewpoint of operability, a solid-liquid separation method such as filtration is preferably used. The drying may be carried out by a heating treatment, or may be carried out using blast drying, vacuum drying, or the like. The temperature at the time of heating treatment is normally from about 50° C. to 300° C., more preferably from about 100° C. to 200° C. Moreover, by carrying out spray drying, the solid-liquid separation and the drying may be continuously carried out.

### <Lithium Mixed Metal Oxide and Method for Producing the Same>

The following description will discuss a lithium mixed metal oxide and a method for producing the same. In the present invention, the lithium mixed metal oxide is produced by calcining a mixture containing the transition metal mixed hydroxide, a lithium compound and optionally an inactive flux.

Examples of the lithium compound include one or more compounds selected from the group consisting of lithium hydroxide, lithium chloride, lithium nitrate and lithium carbonate. These lithium compounds may be either anhydrides, or hydrates. Among these lithium compounds, lithium hydroxides, lithium carbonates, or both are preferably used.

The inactive flux is preferably a material hardly reacting with the transition metal mixed hydroxide and the lithium compound at the time of calcination. Preferable examples of the inactive flux include chlorides such as NaCl, KCl and NH₄Cl, carbonates such as K₂CO₃ and Na₂CO₃, fluorides such as NaF, KF and NH₄F, and borates, and chlorides and carbonates are more preferably used. By mixing the inactive flux, the reactivity of the transition metal mixed hydroxide and the lithium compound may be controlled so that the particle diameters of the primary particles, the particle diameters of the secondary particles and the BET specific surface area of the resultant lithium mixed metal oxide may be adjusted in some cases. Two or more kinds of the inactive fluxes may be used in combination. The inactive flux may be remained in the lithium mixed metal oxide after the calcination, or may be removed therefrom by washing the lithium mixed metal oxide after the calcination or by evaporation or the like of the inactive flux.

Either dry mixing or wet mixing may be used in the mixing. From the viewpoint of convenience, dry mixing is preferably carried out. Examples of a mixing apparatus include a stirring mixer, a V-type mixer, a W-type mixer, a ribbon mixer, a drum mixer, and a ball mill. Among these, from the viewpoint of carrying out mixing while the particle shape of the secondary particles in the transition metal mixed hydroxide is retained in an approximately spherical shape, a stirring mixer, a V-type mixer, a W-type mixer, a drum mixer and the like are preferably used.

In the present invention, the lithium mixed metal oxide consists of primary particles and secondary particles formed by aggregation of primary particles. The retention temperature during the calcination is an important factor from the viewpoint of adjusting the primary particle diameter, secondary particle diameter and BET specific surface area of the lithium mixed metal oxide. Normally, as the retention temperature becomes higher, the primary particle diameter and secondary particle diameter of the lithium mixed metal oxide tend to become larger, while the BET specific surface area of the lithium mixed metal oxide tends to become smaller. Since the secondary particles of the lithium mixed metal oxide easily retain the particle shape of the transition metal mixed hydroxide serving as a raw material, they are easily formed into an approximately spherical shape. In the case where such a lithium mixed metal oxide is used as a positive electrode active material for a non-aqueous electrolyte secondary battery, the filling density of the positive electrode active material in an electrode can be improved. Since the capacity of the non-aqueous electrolyte secondary battery is consequently improved, the secondary particles of the lithium mixed metal oxide are preferably formed into an approximately spherical shape. From the viewpoint of obtaining a non-aqueous electrolyte secondary battery with a high output, the primary particles of the lithium mixed metal oxide preferably have an average particle diameter of from 0.05 μm to 2 μm, and more preferably from 0.1 μm to 1 μm. From the viewpoint of suppressing the inner resistance of the resultant non-aqueous electrolyte secondary battery, the lithium mixed metal oxide preferably has an average particle diameter of from 1 μm to 20 μm, and more preferably from 1 μm to 10 μm. The average particle diameter of the primary particles of the lithium mixed metal oxide can be determined by extracting arbitrary 50 primary particles from images (SEM images) obtained by SEM observations, measuring the respective particle diameters, and calculating an average value thereof. In an accumulated particle size distribution curve on a volume basis obtained from laser diffraction scattering particle-size distribution measurements, the average particle diameter of the lithium mixed metal oxide corresponds to a particle diameter (D₅₀) at 50% accumulation measured from the finest particle side of the curve.

From the viewpoint of setting the average particle diameter of the lithium mixed metal oxide in a desired range, the retention temperature in the calcination is preferably from 650° C. to 1100° C. The period of time during which the calcination is retained at the temperature is normally from 0.1 to 20 hours, and more preferably from 0.5 to 10 hours. The temperature rising rate up to the retention temperature is normally from 50° C./hour to 400° C./hour, and the temperature lowering rate from the retention temperature to room temperature is normally from 10° C./hour to 400° C./hour. As the calcining atmosphere, atmospheric air, oxygen, nitrogen, argon or a mixed gas thereof may be used, and preferably atmospheric air is used.

After the calcination, the resultant lithium mixed metal oxide may be pulverized using a ball mill or the like, or may be classified so as to obtain a desired particle-size distribution. By carrying out the pulverization or classification, the BET specific surface area of the lithium mixed metal oxide may be adjusted in some cases. The pulverization and the classification may be repeated two or more times, and the pulverization, the classification and the calcination may repeated two or more times. The lithium mixed metal oxide may be washed, if necessary.

Since the above-mentioned lithium mixed metal oxide is superior in filling density in an electrode, it is extremely usable as a positive electrode active material of a non-aqueous electrolyte secondary battery having high capacity, with an increase in inner resistance being suppressed.

A compound other than the lithium mixed metal oxide may be attached to the surface of each of particles forming the lithium mixed metal oxide. Examples of the compound include compounds containing one or more elements selected from the group consisting of B, C, Al, Ga, In, Si, Ge, Sn, Mg and transition metal elements, preferably, compounds containing one or more elements selected from the group consisting of B, C, Al, Mg, Ge, In and Sn, and more preferably compounds of Al. More specific examples of the compound include an oxide, hydroxide, oxyhydroxide, carbonate, nitrate and organic acid salt of the above-mentioned elements, and preferably, an oxide, hydroxide and oxyhydroxide thereof. These compounds may be used in a mixed manner. Among these compounds, alumina is the most preferable compound. After the attachment, heating may be carried out.

<Electrode having Lithium Mixed Metal Oxide: Positive Electrode>

A lithium mixed metal oxide acts as a positive electrode active material in a non-aqueous electrolyte secondary battery, and an electrode containing the lithium mixed metal oxide acts as a positive electrode in a non-aqueous electrolyte secondary battery. The following description will discuss a method for producing an electrode having a lithium mixed metal oxide (hereinafter, referred to as positive electrode) by using the lithium mixed metal oxide (hereinafter, referred to as positive electrode active material).

The positive electrode is produced by supporting a positive electrode mixture including a positive electrode active material, a conductive material and a binder onto a positive electrode collector. Examples of the conductive material include carbonaceous materials. Examples of the carbonaceous material include a graphite powder, carbon black, acetylene black, and a fiber-state carbonaceous material. Carbon black or acetylene black is in the form of fine particles with a large surface area. When a small amount of carbon black or acetylene black is added to the positive electrode mixture, the conductivity inside the positive electrode becomes higher so that the charging/discharging efficiency and rate characteristic of a secondary battery are improved. However, in the case where too much of carbon black or acetylene black is added to the positive electrode mixture, the bonding property of the binder, which is exerted between the positive electrode mixture and the positive electrode collector, is lowered, resulting in an increase in resistivity inside the positive electrode. The ratio of the conductive material in the positive electrode mixture is normally from 5 parts by weight to 20 parts by weight based on 100 parts by weight of the positive electrode active material. When the conductive material is a fiber-state carbonaceous material such as a graphitized carbon fiber or a carbon nanotube, this ratio can be lowered.

Examples of the binder include thermoplastic resins, and specific examples of the thermoplastic resin include fluorine resins such as polyvinylidene fluoride (hereinafter, may be sometimes referred to as PVdF), polytetrafluoroethylene (hereinafter, may be sometimes referred to as PTFE), tetrafluoroethylene-hexafluoropropylene-vinylidene fluoride copolymers, hexafluoropropylene-vinylidene fluoride copolymers, and tetrafluoroethylene-perfluorovinyl ether copolymers; and polyolefin resins such as polyethylene and polypropylene. Two or more kinds of these may be mixed with one another and used. A fluorine resin and a polyolefin resin may be used as the binder, and by allowing the positive electrode mixture to contain these resins so as to have a ratio of the fluorine resin from 1% by weight to 10% by weight as well as a ratio of the polyolefin resin from 0.1% by weight to 2% by weight relative to the positive electrode mixture, a positive electrode mixture having a superior bonding property to the positive electrode collector can be obtained.

Examples of the positive electrode collector include Al, Ni, and stainless steel, and Al is preferably used from the viewpoints of being easily formed into a thin film and of low costs. Examples of a method of supporting the positive electrode mixture on the positive electrode collector include a pressure molding method and a method in which a positive electrode mixture paste is obtained by further using an organic solvent or the like, and then the paste is applied to the positive electrode collector, followed by drying, and the resulting sheet is pressed so that the positive electrode mixture is anchored to the collector. The paste contains a positive electrode active material, a conductive material, a binder and an organic solvent. Examples of the organic solvent include amine-based solvents such as N,N-dimethylaminopropylamine and diethylenetriamine, ether-based solvents such as tetrahydrofuran, ketone-based solvents such as methylethyl ketone, ester-based solvents such as methyl acetate, and amide-based solvents such as dimethyl acetoamide and N-methyl-2-pyrrolidone (hereinafter, may be sometimes referred to as NMP).

Examples of a method of applying the positive electrode mixture paste onto the positive electrode collector include a slit-die coating method, a screen coating method, a curtain coating method, a knife coating method, a gravure coating method, and an electrostatic spraying method. By using the processes as described above, a positive electrode can be manufactured.

### <Non-aqueous Electrolyte Secondary Battery>

Next, as a method for producing a non-aqueous electrolyte secondary battery having the above-mentioned positive electrode, examples of producing a lithium secondary battery will be described. The lithium secondary battery can be produced through processes in which a group of electrodes, each obtained by stacking or stacking and winding a separator, a negative electrode, a separator and a positive electrode, is housed in a battery case such as a battery can, and an electrolytic solution is injected into the case.

Examples of the shape of the group of electrodes include shapes having a cross section such as a circular shape, an elliptical shape, a rectangular shape or a rectangular shape with round corners, when the group of electrodes was cut in the direction perpendicular to the axis of winding of the group of electrodes. Examples of the shape of the battery include a paper shape, a coin shape, a cylinder shape, and a rectangular shape.

### <Negative Electrode for Non-aqueous Electrolyte Secondary Battery>

The negative electrode may be designed to be doped and dedoped with the lithium ions at a potential lower than that of the positive electrode. Examples of the negative electrode include an electrode formed by supporting a negative electrode mixture containing a negative electrode material on a negative electrode collector, or an electrode consisting of solely a negative electrode material. Examples of the negative electrode material include materials such as a carbonaceous material, a chalcogen compound (an oxide, a sulfide, etc.), a nitride, metal and an alloy, which can be doped and dedoped with lithium ions at a potential lower than that of the positive electrode. These negative electrode materials may be mixed and used.

The negative electrode material is exemplified in the following materials. Specific examples of the carbonaceous material include graphites such natural graphite and artificial graphite, cokes, carbon black, thermally decomposable carbons, carbon fibers, and sintered polymeric materials. Specific examples of the oxide include oxides of silicon represented by the formula SiO (wherein x is a positive real number) such as SiO₂ and SiO, oxides of titanium represented by the formula TiO (wherein x is a positive real number) such as TiO₂ and TiO, oxides of vanadium represented by the formula VOₓ (wherein x is a positive real number) such as V₂O₅ and VO₂, oxides of iron represented by the formula FeOₓ (wherein x is a positive real number) such as Fe₃O₄, Fe₂O₃ and FeO, oxides of tin represented by the formula SnOₓ (wherein x is a positive real number) such as SnO₂ and

SnO, oxides of tungsten represented by the general formula WOₓ (wherein x is a positive real number) such as WO₃ and WO₂, and mixed metal oxides containing lithium and titanium and/or vanadium such as Li₄Ti₅O₁₂ and LiVO₂ (including Li_{1.1}V_{0.9}O₂). Specific examples of the sulfide include sulfides of titanium represented by the formula TiSₓ (wherein x is a positive real number) such as Ti₂S₃, TiS₂ and TiS, sulfides of vanadium represented by the formula VSₓ (wherein x is a positive real number) such as V₃S₄, VS₂ and VS, sulfides of iron represented by the formula FeSₓ (wherein x is a positive real number) such as Fe₃S₄, FeS₂ and FeS, sulfides of molybdenum represented by the formula MoSₓ (wherein x is a positive real number) such as Mo₂S₃ and MoS₂, sulfides of tin represented by the formula SnSₓ (wherein x is a positive real number) such as SnS₂ and SnS, sulfides of tungsten represented by the formula WSₓ (wherein x is a positive real number) such as WS₂, sulfides of antimony represented by the formula SbSₓ (wherein x is a positive real number) such as Sb₂S₃, and sulfides of selenium represented by the formula SeSₓ (wherein x is a positive real number) such as Se₅S₃, SeS₂ and SeS. Specific examples of the nitride include lithium-containing nitrides such as Li₃N and Li₃₋ₓAₓN (wherein A represents Ni and/or Co, and 0<x<3 is satisfied). Two or more kinds of these carbonaceous materials, oxides, sulfides and nitrides may be used in combination. These materials may be crystalline or amorphous. Each of these carbonaceous materials, oxides, sulfides and nitrides is mainly supported on a negative electrode collector, and used as an electrode.

Specific examples of the metal include lithium metal, silicon metal and tin metal. Specific examples of the alloy include lithium alloys such as Li—Al, Li—Ni and Li—Si, silicon alloys such as Si—Zn, tin alloys such as Sn—Mn, Sn—Co, Sn—Ni, Sn—Cu and Sn—La, and other alloys such as Cu₂Sb and La₃Ni₂Sn₇. Each of these metals and alloys is mainly used solely as an electrode (for example, as a foil).

From the viewpoints of high potential flatness, low average discharging potential and good cycling characteristics of the resultant secondary battery, the negative electrode material is preferably a carbonaceous material mainly composed of graphite such as natural graphite or artificial graphite. Examples of the shape of the carbonaceous material include a flaky shape such as natural graphite, a spherical shape such as meso-carbon microbeads, a fiber shape such as graphitized carbon fibers, and an aggregate of fine powders.

The negative electrode mixture may contain a binder, if necessary. Examples of the binder include thermoplastic resins. Specific examples of the thermoplastic resin include PVdF, thermoplastic polyimide, carboxymethyl cellulose, polyethylene, and polypropylene.

Examples of the negative electrode collector include Cu, Ni, and stainless steel, and from the viewpoints of hardly forming an alloy with lithium and of being easily processed into a thin film, Cu is preferably used. Examples of a method of supporting the negative electrode mixture onto the negative electrode collector include the same methods as those of the positive electrode, that is, a pressure molding method and a method in which a negative electrode mixture paste is obtained by further using a solvent or the like, and then the paste is applied to the negative electrode collector, followed by drying, and the resulting sheet is pressed so that the negative electrode mixture is anchored to the collector.

### <Separator for Non-aqueous Electrolyte Secondary Battery>

Examples of the separator include members having various material modes such as a porous film, a nonwoven cloth, and a woven cloth, which are made from materials such as polyolefin resins including polyethylene and polypropylene, fluorine resins, and nitrogen-containing aromatic copolymers. The separator may be made from two or more kinds of the above-mentioned materials, or may be a laminated separator which has the above-mentioned members laminated to each other. Examples of the separator include those separators disclosed in, for example, JP2000-30686A and JP10-324758A. From the viewpoint of increasing the volume energy of the battery with a reduction in inner resistance, the separator has the thickness of normally from about 5 to 200 μm, and preferably from about 5 to 40 μm. The separator is preferably made as thin as possible, so long as its mechanical strength can be maintained.

The separator preferably includes a porous film containing a thermoplastic resin. In a non-aqueous electrolyte secondary battery, the separator is disposed between the positive electrode and the negative electrode. The separator is preferably designed to have such a function that, when an abnormal current flows in a battery due to a short circuit or the like between positive and negative electrodes, it interrupts the current to prevent (shutdown) an excessive current from flowing therethrough. In this case, the shutdown is carried out by clogging the fine pores of the porous film in the separator when the normally used temperature is exceeded. Even when, after the shutdown, the temperature inside the battery rises to a certain degree of high temperature, the shutdown state is preferably maintained without being film-ruptured by the temperature. Examples of such a separator include a laminated film which has a heat resistant porous layer and a porous film laminated to each other. By using the film as the separator, the heat resistant property of the secondary battery is further improved. The heat resistant porous layer may be stacked on the both surfaces of the porous film.

### <Separator for Non-aqueous Electrolyte Secondary Battery: Laminated Film>

The following description will discuss the laminated film which has the heat resistant porous layer and the porous film laminated to each other.

In the laminated film, the heat resistant porous layer is a layer having a heat resistant property higher than that of the porous film, and the heat resistant porous layer may be formed from an inorganic powder, or may contain a heat resistant resin. By allowing the heat resistant porous layer to contain a heat resistant resin, it is possible to form a heat resistant porous layer by using an easy procedure such as coating techniques. Examples of the heat resistant resin include polyamide, polyimide, polyamideimide, polycarbonate, polyacetal, polysulfone, polyphenylene sulfide, polyetherketone, aromatic polyester, polyether sulfone and polyether imide, and from the viewpoint of further improving the heat resistant property, polyamide, polyimide, polyamideimide, polyether sulfone and polyether imide are preferable, more preferably, polyamide, polyimide and polyamideimide, furthermore preferably, nitrogen-containing aromatic polymers such as aromatic polyamides (para-oriented aromatic polyamides, meta-oriented aromatic polyamides), aromatic polyimides, and aromatic polyamideimides, and still furthermore preferably aromatic polyamides, and from the viewpoint of production, particularly preferably para-oriented aromatic polyamides (hereinafter, sometimes referred to as “para-aramide”). Moreover, examples of the heat resistant resin include poly-4-nethylpentene-1 and cyclic olefin-based polymers. By using these heat resistant resins, the heat resistant property of the laminated film, that is, the thermal film-rupturing temperature of the laminated film can be improved. In the case where, among these heat resistant resins, the nitrogen-containing aromatic polymer is used, good compatibility with an electrolytic solution may be sometimes exerted because of the polarity inside its molecule, and in such a case, the liquid-holding property of the electrolytic solution in the heat resistant porous layer is improved. Thus, upon production of a non-aqueous electrolyte secondary battery, the injecting rate of the electrolytic solution becomes faster, and the charging/discharge capacity of the non-aqueous electrolyte secondary battery is also increased.

The thermal film-rupturing temperature of the laminated film depends on the kind of the heat resistant resin, and is selected and used in accordance with the application state and application purpose. More specifically, in the case where the nitrogen-containing aromatic polymer is used as the heat resistant resin, the thermal film-rupturing temperature can be controlled to about 400° C., in the case where poly-4-methylpentene-1 is used, it can be controlled to about 250° C., and in the case where a cyclic olefin-based polymer is used, it can be controlled to about 300° C., respectively. In the case where the heat resistant porous layer is made from an inorganic powder, the thermal film-rupturing temperature can be controlled to, for example, not less than 500° C.

The para-aramide can be obtained by condensation polymerization between a para-oriented aromatic diamine and a para-oriented aromatic dicarboxylic acid halide, and its amide bonds are virtually composed of repeating units bonded at the para position or corresponding oriented position of an aromatic ring (for example, an oriented position extending coaxially in the opposite direction or in parallel therewith, such as 4,4′-biphenylene, 1,5-naphthalene, and 2,6-naphthalene). Specific examples thereof include para-aramides having a para-oriented structure or a structure corresponding to the para-oriented type such as poly(paraphenylene terephthalamide), poly(parabenzamide), poly(4,4′-benzanilide terephthalamide), poly(paraphenylene-4,4′-biphenylene dicarboxylic acid amide), poly(paraphenylene-2,6 naphthalene dicarboxylic acid amide), poly(2-chloro-paraphenylene terephthalamide), and paraphenylene terephthalamide/2,6-dichloroparaphenylene terephthalamide copolymers.

The aromatic polyimide is preferably a total aromatic polyimide produced by condensation polymerization between an aromatic dianhydride and a diamine. Specific examples of the dianhydride include pyromellitic dianhydride, 3,3′,4,4′-diphenylsulfonetetracarboxylic dianhydride, 3,3′,4,4′-benzophenonetetracarboxylic dianhydride, 2,2′-bis(3,4-dicarboxyphenyl)hexafluoropropane and 3,3′,4,4′-biphenyltetracarboxylic dianhydride. Specific examples of the diamine include oxydianiline, paraphenylene diamine, benzophenone diamine, 3,3′-methylene dianiline, 3,3′-diaminobenzophenone, 3,3′-diaminodiphenyl sulfone and 1,5-naphthalene diamine. Moreover, a polyimide that is soluble to a solvent is desirably used. Examples of the polyimide include a polyimide of a polycondensation product between 3,3′,4,4′-diphenylsulfonetetracarboxylic dianhydride and an aromatic diamine.

Examples of the aromatic polyamideimide include a condensation polymerization product between an aromatic dicarboxylic acid and an aromatic diisocyanate, and a condensation polymerization product between an aromatic dianhydride and an aromatic diisocyanate. Specific examples of the aromatic dicarboxylic acid include isophthalic acid and terephthalic acid. Specific examples of the aromatic dianhydride include trimellitic anhydride. Specific examples of the aromatic diisocyanate include 4,4′-diphenylmethane diisocyanate, 2,4-tolylene diisocyanate, 2,6-tolylene diisocyanate, ortho-tolylene diisocyanate, and m-xylene diisocyanate.

From the viewpoint of improving the ion permeability, the thickness of the heat resistant porous layer is desirably made thinner, and specifically, it is preferably from 1 μm to 10 μm, more preferably from 1 μm to 5 μm, and particularly preferably from 1 μm to 4 μm. The heat resistant porous layer has fine pores, and the size (diameter) of each pore is normally not more than 3 μm, and preferably not more than 1 μm. In the case where the heat resistant porous layer contains a heat resistant resin, the heat resistant porous layer may contain a filler, which will be described later.

The porous film in the laminated film has fine pores. The porous film is preferably provided with a shutdown function, and in this case, it contains a thermoplastic resin. Each fine pore of the porous film has a size (diameter) of normally not more than 3 μm, and preferably not more than 1 μm. The porous film has a rate of porosity of normally from 30 to 80% by volume, and preferably from 40 to 70% by volume. In the case where a non-aqueous electrolyte secondary battery is used at a temperature exceeding a normally used temperature, the porous film is allowed to clog the fine pores by softening the thermoplastic resin forming the film.

As the thermoplastic resin, a resin that is not dissolved in an electrolytic solution in the non-aqueous electrolyte secondary battery is selected. Specific examples of the thermoplastic resin include polyolefin resins such as polyethylene and polypropylene, and a thermoplastic polyurethane resin, and two or more kinds of the thermoplastic resins may be mixed and used. From the viewpoint of being softened at a lower temperature to cause shutdown, the porous film preferably contains a polyethylene. Specific examples of the polyethylene include a low-density polyethylene, a high-density polyethylene and a linear polyethylene, and an ultra-high molecular weight polyethylene having a molecular weight of not less than 1,000,000. From the viewpoint of further increasing the sticking-resistant strength of the porous film, the porous film preferably contains an ultra-high molecular weight polyethylene. In order to easily produce the porous film, the thermoplastic resin may be preferably allowed to contain a wax made from polyolefin having a low molecular weight (weight-average molecular weight of not more than 10,000) in some cases.

The porous film in the laminated film has the thickness of normally from 3 to 30 μm, preferably from 3 to 25 μm, and more preferably from 3 to 19 μm. The laminated film has the thickness of normally not more than 40 μm, preferably not more than 30 μm, and more preferably not more than 20 μm. Assuming that the thickness of the heat resistant porous layer is A (μm), and that the thickness of the porous film is B (μm), the value of A/B is preferably from 0.1 to 1.

In the case where the heat resistant porous layer contains a heat resistant resin, the heat resistant porous layer may contain one or more kinds of fillers. The material for the filler may be one or more kinds of materials selected from a organic powder, an inorganic powder and a mixture thereof. Particles forming the filler preferably have an average particle diameter of from 0.01 μm to 1 μm.

Examples of the organic powder include powders made from organic substances such as a single material or a copolymer of two or more kinds of materials including styrene, vinyl ketone, acrylonitrile, methylmethacrylate, ethylmethacrylate, glycidyl methacrylate, glycidyl acrylate and methylacrylate; fluorine resins such as polytetrafluoroethylene, a tetrafluoroethylene-hexafluoropropylene copolymer, a tetrafluoroethylene-ethylene copolymer, and polyvinylidene fluoride; melamine resins; urea resins; polyolefins; and polymethacrylates. Each of these organic powders may be used solely, or two or more kinds thereof may be mixed and used. Among these organic powders, from the viewpoint of chemical stability, a polytetrafluoroethylene powder is preferably used.

Examples of the inorganic powder include powders made from inorganic substances such as metal oxides, metal nitrides, metal carbides, metal hydroxides, carbonates, and sulfates. Among these, powders made from inorganic substances having low conductivity are preferable. Specific examples of the preferable inorganic powder include powders made from alumina, silica, titanium dioxide, and calcium carbonate. Each of these inorganic powders may be used solely, or two or more kinds thereof may be mixed and used. Among these inorganic powders, from the viewpoint of chemical stability, an alumina powder is preferable. More preferably, all the particles forming the alumina powder are composed of alumina particles, and furthermore preferably, all the particles forming the filler are alumina particles, with a portion or all of the alumina particles being substantially spherical shapes. In the case where the heat resistant porous layer is made from inorganic powder, the above-exemplified inorganic powder may be used, and may also be mixed with a binder, if necessary, and used.

In the case where the heat resistant porous layer contains a heat resistant resin, the content of the filler is dependent on the specific gravity of the filler material. For example, when all the particles forming the filler are made of alumina particles, the ratio of the weight of the filler is normally from 5 to 95, preferably from 20 to 95, and more preferably from 30 to 90 based on the total weight 100 of the heat resistant porous layer. These ranges can be appropriately determined depending on the specific gravity of the filler material.

Examples of the filler shape include a substantially spherical shape, a plate shape, a pillar shape, a needle shape, a whisker shape, and a fiber shape, and from the viewpoint of easily forming uniform pores, a substantially spherical shape is preferable. Examples of the substantially spherical particles include particles having an aspect ratio (major axis of particles/minor axis of particles) of particles of not less than 1 and not more than 1.5. The aspect ratio of the particles can be measured by using an electron microscope photograph.

From the viewpoint of the ion permeability of a secondary battery, the separator is preferably provided with a gas permeability measured by a Gurley method of from 50 to 300 seconds/100 ccs, and more preferably from 50 to 200 seconds/100 ccs. The separator has a rate of porosity of normally from 30 to 80% by volume, and more preferably from 40 to 70% by volume. The separator may be formed by stacking separators having different porosities.

### <Electrolytic Solution or Solid-state of Non-aqueous Electrolyte Secondary Battery>

An electrolytic solution normally contains an electrolyte and an organic solvent. Examples of the electrolyte include lithium salts such as LiClO₄, LiPF₆, LiAsF₆, LiSbF₆, LiBF₄, LiCF₃SO₃, LiN(SO₂CF₃)₂, LiN (SO₂C₂F₅)₂, LiN(SO₂CF₃) (COCF₃), Li(C₄F₉SO₃), LiC(SO₂CF₃)₃, Li₂B₁₀Cl₁₀, LiBOB (in this case, BOB represents bis(oxalato)borate), lithium salt of lower aliphatic carboxylic acid, and LiAlCl₄, and two or more kinds of the electrolytes may be mixed and used. Normally, among these, one or more kinds of fluorine-containing lithium salts selected from the group consisting of LiPF₆, LiAsF₆, LiSbF₆, LiCF₃SO₃, LiN (SO₂CF₃)₂ and LiC(SO₂CF₃)₃ are used.

In the electrolytic solution, examples of the organic solvent include carbonates such as propylene carbonate, ethylene carbonate (hereinafter, sometimes referred to as EC), dimethyl carbonate (hereinafter, sometimes referred to as DMC), diethyl carbonate, ethylmethyl carbonate (hereinafter, sometimes referred to as EMC), 4-trifluoromethyl-1,3-dioxolan-2-one and 1,2-di(methoxycarbonyloxy)ethane; ethers such as 1,2-dimethoxyethane, 1,3-dimethoxypropane, pentafluoropropyl methylether, 2,2,3,3-tetrafluoropropyl difluoromethylether, tetrahydrofuran and 2-methyl tetrahydrofuran; esters such as methyl formate, methyl acetate and γ-butyrolactone; nitriles such as acetonitrile and butyronitrile; amides such as N,N-dimethylformamide and N,N-dimethylacetoamide; carbamates such as 3-methyl-2-oxazolidone; sulfur-containing compounds such as sulforan, dimethylsulfoxide and 1,3-propane sultone; and those solvents formed by further introducing a fluorine substituent to the above-mentioned organic solvents. Normally, a mixed solvent obtained by mixing two or more kinds of organic solvents among these solvents is used. Among these, a mixed solvent containing carbonates is preferable, and a mixed solvent of a cyclic carbonate and an acyclic carbonate, or a mixed solvent of a cyclic carbonate and ethers is more preferable. As the mixed solvent of a cyclic carbonate and an acyclic carbonate, a mixed solvent containing EC, DMC and EMC is preferable from the viewpoints of providing a wide operating temperature range, a superior load characteristic and a hardly-decomposing property even in the case of using a graphite material such as natural graphite or artificial graphite as a negative electrode active material. In particular, from the viewpoint of obtaining a superior safety improving effect, an electrolytic solution containing an organic solvent having a fluorine-containing lithium salt such as LiPF₆, and a fluorine substituent is preferably used. A mixed solvent containing ethers having a fluorine substituent such as pentafluoropropyl methyl ether and 2,2,3,3-tetrafluoropropyl difluoromethyl ether and DMC is superior in a large-current discharging characteristic, and it is more preferable.

In place of the electrolytic solution, a solid-state electrolyte may be used. As the solid-state electrolyte, for example, an organic polymer electrolyte such as a polyethylene oxide-based polymer or a polymer containing at least one kind of a polyorgano siloxane chain and a polyoxyalkylene chain may be used. A so-called gel-type electrolyte formed by allowing a polymer to support an electrolytic solution may also be used. An inorganic solid-state electrolyte containing a sulfide such as Li₂S—SiS₂, Li₂S—GeS₂, Li₂S—P₂S₅, Li₂S—B₂S₃, Li₂S—SiS₂—Li₃PO₄ or Li₂S—SiS₂—Li₂SO₄ may be used. By using these solid-state electrolytes, higher safety may be further ensured in some cases. In the non-aqueous electrolyte secondary battery of the present invention, in the case of using a solid-state electrolyte, the solid-state electrolyte may serve as a separator in some cases, and in this case, no separator may be required in some cases.

### EXAMPLES

The following description will further discuss the present invention in detail by means of examples. The evaluations of a transition metal mixed hydroxide and a lithium mixed metal oxide (positive electrode active material) were carried out as follows.

### (1) Manufacture of Positive Electrode

A material obtained by mixing acetylene black and graphite at a ratio of 9:1 was used as a conductive material. PVdF was used as a binder, and a solution of PVDF in NMP was used as a binder solution (PVdF is manufactured by Kureha Corporation, and NMP is manufactured by Tokyo Chemical Industry Co., Ltd.). A positive electrode active material and the conductive material were mixed and then the binder solution was added thereto so as to have the composition of positive electrode active material:conductive agent:binder=87:10:3 (weight ratio), and these were kneaded so that an electrode mixture paste was obtained. An Al foil having the thickness of 40 μm serving as a collector was coated with the paste, and this was dried at 60° C. for 2 hours so that an electrode sheet was obtained. Next, the electrode sheet was rolled at a pressure of 0.5 MPa using a press roller, and this was punched out by a punching machine into a size of 14.5 mmφ, and then vacuum-dried at 150° C. for 8 hours so that electrodes were obtained.

### (2) Production of Non-aqueous Electrolyte Secondary Battery (Coin Cell)

As a separator, a laminated film (thickness: 16 μm) formed by stacking a heat resistant porous layer on a polyethylene porous film to be described later was used. As a solvent for an electrolytic solution, a mixed solvent of EC:DMC:EMC=30:35:35 (volume ratio) was used. As an electrolyte, LiPF₆ was used. The electrolyte was dissolved in the mixed solvent at a rate of 1 mole/liter so that an electrolytic solution 1 was prepared. Metal lithium was used as a negative electrode. The positive electrode was placed on the lower lid of a coin cell (manufactured by Hohsen Corporation) with its aluminum foil surface facing down, and the separator was placed thereon, and then the electrolytic solution 1 (300 μl) was injected thereto. Next, the negative electrode is put on the upper side of the separator, and the upper lid of the coin cell was placed thereon with a gasket interpolated therebetween, and the lid was caulked by using a caulking machine, so that a non-aqueous electrolyte secondary battery (coin-shaped battery R2032) was manufactured. The assembling processes of the battery were carried out in a glove box in an argon atmosphere.

### (3) Evaluation of Non-aqueous Electrolyte Secondary Battery (Coin Cell)

By using the coin-type battery, charging/discharging tests and impedance measurements were carried out under the following conditions. The battery capacity was measured by the charging/discharging tests. The inner resistance of the battery was measured by the impedance measurements.

### <Charging/Discharging Tests>

Test temperature: 25° C.

Charging maximum voltage: 4.3 V

Charging time: 8 hours

Charging current: 0.2 mA/cm² (0.2 C)

Discharging minimum voltage: 3.0 V

Constant current discharging, discharging current: 0.2 mA/cm² (0.2 C)

### <Impedance Measurements>

Test temperature: 25° C.

Charging depth upon measurements (SOC): 100%

AC frequency: 0.01 Hz to 100 Hz

### (4) Evaluation of Transition Metal Mixed Hydroxide and Lithium Mixed Metal Oxide

### 1. Composition Analysis

After dissolving a powder to be measured in hydrochloric acid, the composition of the powder was measured using an SPS 3000 (ICP light emission spectrophotometry) manufactured by Seiko Instruments Inc.

### 2. SEM Observation

On a conductive sheet pasted onto a sample stage, a powder to be observed was mounted, and by using an SEM (JSM-5510 manufactured by JEOL Ltd., an electron beam with an accelerating voltage of 20 kV was applied to the powder so that an SEM observation was carried out to confirm the shape of the secondary particles of the powder. The average primary particle size of the primary particles is determined by extracting arbitrary 50 primary particles from images (SEM images) obtained by SEM observations, measuring the respective particle diameters, and calculating an average value thereof.

### 3. Measurements of Particle Size Distribution

A powder to be measured (0.1 g) was added to 50 ml of a 0.2 wt % aqueous sodium hexamethaphosphate solution, and a dispersion solution with the powder dispersed therein was used as a measuring sample. By using the measuring sample, the particle size distribution of the powder was measured by the use of a Mastersizer 2000 (a laser diffraction scattering particle-size distribution measurement apparatus), manufactured by Malvern Instruments Ltd., and an accumulated particle size distribution curve on a volume basis was obtained. The average particle size thereof corresponds to a particle diameter (D₅₀) at 50% accumulation viewed from the finest particle side of the curve.

### 4. Measurements of Filling Density and Electric Conductivity

By using an MCP-PD51 (powder resistance measurement unit) manufactured by Mitsubishi Chemical Analytech Co., Ltd., 3 g of a measuring powder was filled into a jig having a diameter of 20 mmφ, and the filling density and electric conductivity of the powder under constant pressure were measured.

### Comparative Example 1

### 1. Production of Lithium Mixed Metal Oxide

Manganese nitrate was used as a water-soluble manganese salt, nickel nitrate was used as a water-soluble nickel salt, and iron sulfate (II) was used as a water-soluble iron salt. These components were precisely weighed respectively so as to adjust a molar ratio of Mn:Ni:Fe to 0.45:0.45:0.1, and dissolved in pure water so that an aqueous transition metal solution containing Ni, Mn and Fe was obtained. To this aqueous transition metal solution was added an aqueous sodium hydroxide solution as an aqueous alkali metal solution so as to allow transition metal ions to be coprecipitated so that a slurry was obtained. At the time of the coprecipitation, the pH and temperature of the solution inside the reaction vessel were not adjusted, and the inside of the reaction vessel was stirred by a stirring blade. The resultant slurry was solid-liquid separated, and the resultant solid component was washed with distilled water and dried at 150° C. so that a transition metal mixed hydroxide (Q₁) was obtained.

The composition analysis of the powder Q₁ was carried out and found to have a molar ratio of Mn:Ni:Fe of 0.45:0.45:0.1. It was confirmed by the SEM observation of the powder Q₁ that each of the secondary particles had an irregular shape. The powder Q₁ had an average particle diameter of 44 μm.

### 2. Production and Evaluation of Lithium Mixed Metal Oxide

The powder Q₁, a lithium hydroxide monohydrate and potassium chloride serving as an inactive flux were mixed in a mortar so that a mixture was obtained. The mixture was put into a calcining container made of alumina, and retained using an electric furnace at 850° C. in the atmospheric air for 6 hours so as to be calcined, and cooled to room temperature so that a powder R₁ was obtained.

The composition analysis of the powder R₁ was carried out and found to have a molar ratio of Li:Mn:Ni:Fe of 1.05:0.45:0.45:0.1. It was confirmed by the SEM observation of the powder R₁ that each of the secondary particles had an irregular shape. The powder R₁ had an average particle diameter of 0.2 μm. Upon applying a load of 12 kN, the powder R₁ had a filling density of 2.7 g/cc, and an electric conductivity of 4×10⁻⁶ S/cm.

### 3. Charging/Discharging Tests and Impedance Measurements of Non-aqueous Electrolyte Secondary Battery

A positive electrode was manufactured using the powder R₁. A coin-type battery was manufactured using this positive electrode, and when charging/discharging tests were carried out thereon, the battery had a battery capacity of 1.5 mAh (mass of positive electrode active material: 0.010 g). As a result of impedance measurements, the battery had an inner resistance of 10 Ω.

### Example 1

### 1. Production and Evaluation of Transition Metal Mixed Hydroxide

Manganese sulfate was used as a water-soluble manganese salt, nickel sulfate was used as a water-soluble nickel salt, an iron sulfate (II) was used as a water-soluble iron salt. These components were precisely weighed respectively so as to adjust a molar ratio of Mn:Ni:Fe to 0.48:0.47:0.05, and dissolved in pure water so that an aqueous transition metal solution containing Ni, Mn and Fe was obtained. An aqueous ammonium sulfate solution was used as a complexing agent, and an aqueous sodium hydroxide solution was used as an aqueous alkali metal solution. By simultaneously supplying the aqueous transition metal solution, the complexing agent and the aqueous alkali metal solution into a reaction vessel continuously, transition metal ions were coprecipitate to obtain a slurry. At the time of the coprecipitation, the amount of the aqueous sodium hydroxide solution charged was adjusted so as to retain the pH of the liquid in the reaction vessel at 12, and the temperature in the reaction vessel was adjusted to 45° C. Moreover, the inside of the reaction vessel was stirred by a stirring blade. The resultant slurry was solid-liquid separated, and the resultant solid component was washed with distilled water, and dried at 100° C. so that a transition metal mixed hydroxide (P₁) was obtained.

The composition analysis of the powder P₁ was carried out and found to have a molar ratio of Mn:Ni:Fe of 0.48:0.47:0.05. It was confirmed by the SEM observation of the powder P₁ that each of the secondary particles had an approximately spherical shape. The powder P₁ had an average particle diameter of 9 μm.

### 2. Production and Evaluation of Lithium Mixed Metal Oxide

The powder P₁ and a lithium hydroxide monohydrate were mixed in a mortar so that a mixture was obtained. The mixture was put into a calcining container made of alumina, and retained using an electric furnace at 850° C. in the atmospheric air for 6 hours so as to be calcined, and cooled to room temperature so that a powder A₁ was obtained.

The composition analysis of the powder Aₗ was carried out and found to have a molar ratio of Li:Mn:Ni:Fe of 1.05:0.48:0.47:0.05. It was confirmed by the SEM observation of the powder A₁ that each of the secondary particles had an approximately spherical shape. The powder A₁ had an average particle diameter of 9 μm. Upon applying a load of 12 kN, the powder A₁ had a filling density of 3.1 g/cc, which was greater than that of Comparative Example 1. Upon applying a load of 12 kN, the powder A₁ had an electric conductivity of 8×10⁻⁵ S/cm, which was greater than that of Comparative Example 1.

### 3. Charging/Discharging Tests and Impedance Measurements of Non-aqueous Electrolyte Secondary Battery

A positive electrode was manufactured using the powder A₁. A coin-type battery was manufactured using this positive electrode, and when charging/discharging tests were carried out thereon, the battery had a battery capacity of 1.8 mAh (mass of positive electrode active material: 0.011 g), which was greater than that of Comparative Example 1. As a result of impedance measurements, the battery had an inner resistance of 7 Ω, which was confirmed to be smaller than that of Comparative Example 1.

### Example 2

### 1. Production and Evaluation of Transition Metal Mixed Hydroxide

A transition metal mixed hydroxide (P₂) was obtained by carrying out the same operation as in Example 1 except that the molar ratio of Mn:Ni:Fe was 0.46:0.44:0.1.

The composition analysis of the powder P2 was carried out and found that the molar ratio of Mn:Ni:Fe was 0.46:0.44:0.1. It was confirmed by the SEM observation of the powder P₂ that each of the secondary particles had an approximately spherical shape. The powder P₂ had an average particle diameter of 8 μm.

### 2. Production and Evaluation of Lithium Mixed Metal Oxide

The powder P₂ and a lithium hydroxide monohydrate were mixed in a mortar so that a mixture was obtained. The mixture was put into a calcining container made of alumina, and retained using an electric furnace at 850° C. in the atmospheric air for 6 hours so as to be calcined, and cooled to room temperature so that a powder A₂ was obtained.

The composition analysis of the powder A₂ was carried out and found to have a molar ratio of Li:Mn:Ni:Fe of 1.07:0.46:0.44:0.1. It was confirmed by the SEM observation of the powder A₂ that each of the secondary particles had an approximately spherical shape. The powder A₂ had an average particle diameter of 8 μm. Upon applying a load of 12 kN, the powder A₂ had a filling density of 3.0 g/cc, which was greater than that of Comparative Example 1. Upon applying a load of 12 kN, the powder A₂ had an electric conductivity of 2×10⁻⁵S/cm, which was greater than that of Comparative Example 1.

### 3. Charging/Discharging Tests and Impedance Measurements of Non-aqueous Electrolyte Secondary Battery

A positive electrode was manufactured using the powder A₂. A coin-type battery was manufactured using this positive electrode, and when charging/discharging tests were carried out thereon, the battery had a battery capacity of 1.7 mAh (mass of positive electrode active material: 0.011 g), which was greater than that of Comparative Example 1. As a result of impedance measurements, the battery had an inner resistance of 8 Ω, which was confirmed to be smaller than that of Comparative Example 1.

### Production Example 1 (Production of Laminated Film)

### (1) Production of Slurry for Application

After 272.7 g of calcium chloride had been dissolved in 4200 g of NMP, to this was added 132.9 g of paraphenylene diamine and completely dissolved therein. To the resultant solution was gradually added 243.3 g of terephthaloyl dichloride to be polymerized so that para-aramide was obtained, and this was further diluted with NMP so that a para-aramide solution (A) having a concentration of 2.0% by weight was obtained. To the resultant para-aramide solution (100 g) were added 2 g of an alumina powder (a) (alumina C, manufactured by Japan Aerosil Inc., average particle diameter: 0.02 μm) and 2 g of an alumina powder (b) (Sumicorundum AA03, manufactured by Sumitomo Chemical Co., Ltd., average particle diameter: 0.3 μm), that is, the total of 4 g, and mixed therein as fillers, and this was processed by a nanomizer three times, and further filtered by a wire gauze with 1000 meshes, and then defoamed under reduced pressure so that a slurry for application (B) was produced. The weight of the alumina powder (filler) relative to the total weight of the para-aramide and the alumina powder was 67% by weight.

### (2) Production and Valuation of Laminated Film

As a porous film, a polyethylene porous film (film thickness: 12 μm, gas permeability: 140 seconds/100 ccs, average pore diameter: 0.1 μm, rate of porosity: 50%) was used. The polyethylene porous film was secured onto a PET film having the thickness of 100 μm, and the slurry for application (B) was applied onto the porous film by using a bar coater manufactured by Tester Sangyo Co., Ltd. The PET film and the coated porous film were immersed into water while being integrally kept so that a para-aramide porous film (heat resistant layer) was deposited thereon, and the solvent was then dried so that a laminated film 1 having the heat resistant porous layer and the porous film laminated to each other was obtained. The laminated film 1 had the thickness of 16 μm, and the para-aramide porous film (heat resistant porous layer) had the thickness of 4 μm. The laminated film 1 had a gas permeability of 180 seconds/100 ccs, and had a rate of porosity of 50%. When the cross section of the heat resistant porous layer in the laminated film 1 was observed by a scanning electron microscope (SEM), it was found that comparatively small fine pores in a range from about 0.03 μm to 0.06 μm and comparatively large fine pores in a range from about 0.1 μm to 1 μm were present. The evaluations on the laminated film were carried out by the following method.

### <Evaluation of Laminated Film>

### (A) Thickness Measurements

The thickness of the laminated film and the thickness of the porous film were measured in accordance with JIS Standard (K7130-1992). Moreover, a value obtained by subtracting the thickness of the porous film from the thickness of the laminated film was used as the thickness of the heat resistant porous layer.

(B) Measurements of Gas Permeability by Gurley method

The gas permeability of the laminated film was measured in accordance with JIS P8117 by using a digital timer-type Gurley type Densometer manufactured by Yasuda Seiki Seisakusho Ltd.

### (C) Rate of Porosity

The sample of the resulting laminated film was cut out into a square having a length of 10 cm in each side, and the weight W(g) and the thickness D (cm) were measured. The weights of the respective layers in the sample (Wi(g); i is an integer from 1 to n) were obtained, and based upon Wi and the true specific gravity (true specific gravity i (g/cm³)) of the material of each layer, the volume of each of the layers was obtained, and the rate of porosity (% by volume) was calculated from the following expression:

Rate of porosity (% by volume)=100×{1−(W1/True Specific Gravity 1+W2/True Specific Gravity 2+ . . +Wn/True Specific Gravity n)/(10×10×D)}

### INDUSTRIAL APPLICABILITY

The present invention can provide a non-aqueous electrolyte secondary battery having higher capacity and lower inner resistance in comparison with a conventional lithium secondary battery. The present invention is effectively usable in, in particular, applications requiring a high output at a high current rate, that is, in a non-aqueous electrolyte secondary battery for automobiles and power tools such as electric tools.

1. A transition metal mixed hydroxide consisting of primary particles and approximately spherical secondary particles formed by aggregation of primary particles, wherein the transition metal mixed hydroxide has an average particle diameter of from 1 μm to 20 μm and contains Mn, Ni, Fe and Co in a molar ratio of a:b:c:d, wherein a is from 0.3 to 0.7, b is from 0.4 to 0.7, c is more than 0 and not more than 0.1, d is from 0 to 0.2, and a+b+c+d=1.

2. The transition metal mixed hydroxide according to claim 1, wherein a is larger than b.

3. The transition metal mixed hydroxide according to claim 1, wherein d is 0.

4. The transition metal mixed hydroxide according to claim 1, wherein the average particle diameter is from 1 μm to 10 μm.

5. A lithium mixed metal oxide produced by calcining a mixture of the transition metal mixed hydroxide according to claim 1 and a lithium compound, wherein the lithium mixed metal oxide has an average particle diameter of from 1 μm to 20 μm

6. An electrode comprising the lithium mixed metal oxide according to claim 5.

7. A non-aqueous electrolyte secondary battery comprising the electrode according to claim 6 as a positive electrode.

8. The non-aqueous electrolyte secondary battery according to claim 7 further comprising a separator.

9. The non-aqueous electrolyte secondary battery according to claim 8, wherein the separator is composed of a laminated film which has a heat resistant porous layer and a porous film laminated to each other.
